(19) United States
(12) Patent Application Publication
(10) Pub. No.: US 2026/0122121 A1
(43) Pub. Date: Apr. 30, 2026

(54) Method for managing access by a playback device to segmented content

(71) Applicant: Orange, Issy-les-Moulineaux (FR)

(72) Inventors: Olivier GASTE, CHATILLON CEDEX (FR); Hervé MARCHAND, CHATILLON CEDEX (FR)

(21) Appl. No.: 19/367,049

(22) Filed: Oct. 23, 2025

(30) Foreign Application Priority Data
Oct. 24, 2024 (FR) FR2411612

(51) Int. Cl. H04L 65/75; H04L 67/02

(52) U.S. Cl. CPC H04L 65/75; H04L 67/02

(57) ABSTRACT

A method for managing access by a playback device to a first segmented content, the segments of which are described in respective description files. Access to a given first content results in receipt both of description files associated with the first segmented content at a given frequency and of description files associated with a second content at another frequency.

### CROSS REFERENCE TO RELATED APPLICATION

The present application claims priority to and the benefit of French Patent Application No. FR2411612, filed Oct. 24, 2024, the content of which is hereby incorporated by reference in its entirety.

### TECHNICAL FIELD

The field of the present disclosure is that of managing access by a playback device to segmented content associated with respective description files describing addresses for accessing the content.

The focus of an aspect of the present disclosure is most particularly on segmented content that is accessible in multiple formats associated with respective sizes in bytes having more or less effect on the bandwidth of the network from which the content is downloaded. The focus of an aspect of the present disclosure is most particularly on content downloaded using a technique referred to as HTTP adaptive streaming, or HAS, or any other download techniques that use the same principle.

A description file, for example the one used in the context of HTTP adaptive streaming, is a file comprising, inter alia, network addresses (IP address or URL) of the segments to be downloaded and played back by a playback device. In other words, a description file describes segments in the form of network addresses, it being up to the playback device to access these segments via a network, for example the Internet.

The focus of the playback device is on any data processing device that is equipped with a processor and capable of accessing segments of content through a network, of receiving the segments from a network, possibly of decoding the received segments if they are coded and of requesting that the decoded segments be rendered, for example on a screen integrated in the playback device or external to the playback device.

### PRIOR ART

When a multimedia content is accessed, a playback device sends a request to a content server indicating the chosen multimedia (video and/or audio) content. The playback device receives, in return, a digital data stream relating to this content. In the context of a local area communication network, such a request may transit via a network access gateway, for example a residential gateway.

The received data are then decoded by the playback device before being rendered in the form of a display of the corresponding video.

The broadcast of digital content over the Internet is often based on client-server protocols of the HTTP (Hypertext Transport Protocol) family. In particular, HTTP adaptive streaming (HAS) of digital content allows the data to be transported and read in real time, i.e. the digital data are transmitted over the network and rendered by the playback device as they arrive. Following receipt of the stream, the playback device stores received data in a buffer memory before rendering them. This form of distribution is particularly useful when the bit rate available to the user is not guaranteed for realtime transfer of the video.

HTTP adaptive streaming additionally permits data to be broadcast and received with various qualities corresponding, for example, to various respective encoding rates. These various qualities are described in the aforementioned description file.

When a user accesses the live stream broadcast using HTTP adaptive streaming (HAS), the playback device receives, at regular intervals, usually every two seconds, a description file that generally describes the last sixty seconds of the stream (thirty (30) segments of two (2) seconds) by providing IP (Internet Protocol) addresses of segments corresponding to these last sixty seconds. By successively receiving this description file, the playback device can play back the content continuously.

Usually, the video segments are chosen to be of short duration because it is desirable to be as close as possible to the stream broadcast in real time, which those skilled in the art also call the live stream.

It will be noted that an encoding rate is selected from the available rates depending on the available bandwidth or on the storage and decoding capabilities of the playback device. This type of technique takes into account variations in bandwidth on the link between the client playback device and the content server.

Currently, when a live channel broadcast using HAS is “zapped” on, the playback device (more precisely an entity managing HAS download) receives from the network the description file relating to the selected channel. This description file usually describes about one minute of content for a live channel (segments having a life of less than 1 minute are listed therein). Having retrieved the description file, the playback device will then usually retrieve the two most recent video and audio segments using the segment addresses described in the description file; then, the playback device STB, before starting to play back the segments of video content, will then retrieve the subsequent segments by trying to maintain a reception buffer of about fifteen seconds.

A certain delay is therefore noticeable between the time at which a description file is received and playback of the corresponding content. This delay can affect the experience of a user looking for quick access to a content.

One or more aspects of the present disclosure improve the situation.

### SUMMARY

According to a first functional aspect, the present disclosure relates to a method of managing access by a playback device to a first segmented content, the segments of which are described in respective description files, characterized in that access to a first given content results in receipt both of description files associated with this first content at a given frequency and of description files associated with a second content at another frequency.

According to an aspect of the present disclosure, after a request to access a content, multiple description files are successively received in relation to the requested content but also to another content; the description file received in relation to said other content is executed in advance if a user zaps on said other content; if this is the case, the zapping delay will therefore not include the delay related to the request to access the description file and receipt of the description file in return, said description file already having been downloaded in advance when access to this content is requested. The zapping time is therefore reduced and therefore becomes less than that of the prior art; the user experience can only be better.

On the other hand, another significant advantage is that reducing the amount of downloaded data related to a second content permits a greater number of second contents to be selected. Indeed, in an aspect of the present disclosure, unlike the prior art, the audio/video stream associated with the second content, which is large, is not retrieved, but simply the description files; in the case of a second content of television channel type, for each television channel, much less data is downloaded; it is therefore possible to subscribe to a greater number of channels than simply adjacent channels, for example.

Note that receipt of the description files can be simultaneous or staggered in time.

According to one particular embodiment of the disclosure, access to a given content also results in some of the segments described in the description file associated with the second content being downloaded. In this embodiment, some of the segments of the second content are downloaded spontaneously by the server that manages download of the segments; the playback device does not transmit a request to download segments related to the second content, especially since at that time the playback device has not yet received a description file.

According to another particular embodiment of the disclosure, which may be implemented as an alternative or in addition to the previous one, the description files associated with the second content are received at a lower frequency. A choice is made, for example, to receive the description files associated with the first content every two seconds and the description files associated with the second content less often, for example every thirty seconds. In this way, the description files, or even the last segments currently being broadcast on the channel in question that are related to the second content, are retrieved fifteen times less often. This embodiment avoids cluttering the network, in particular when the number of second contents is great (for example, it is possible to have ten to twenty television channels identified as second contents); during a description file update this would approximately double the overall bandwidth used (bandwidth for reading the current content and retrieving the data of the second contents (for example favorite television channels as will be seen below)).

According to another particular embodiment of the present disclosure, which may be implemented as an alternative or in addition to the previous ones, the second content is a content adjacent to the first content. The focus of this embodiment is on the use case in which a user zaps by one unit; said user typically uses the “−/+” zapping keys on the remote control. In this case, anticipating a download of description files for one or even both adjacent channels ensures very fast zapping.

According to another particular embodiment of the present disclosure, which may be implemented as an alternative or in addition to the previous ones, the second content is a content included in a predefined list of contents. The focus of this embodiment is on a use case in which the zapping may be greater than one unit; the focus of this embodiment is typically on zapping by selecting a channel by selecting a channel number on the remote control; for example, assuming that a number is assigned to each channel, the user zaps from the second channel to the ninth channel.

According to a first hardware aspect, the present disclosure relates to a first management entity for managing access by a playback device to a first segmented content, the segments of which are described in respective description files, characterized in that it comprises a module that is able, following access to a given content, to request receipt of description files associated with this first content at a given frequency and of description files associated with a second content at another frequency.

According to another hardware aspect, the present disclosure relates to a playback device comprising a management entity as defined above.

According to another hardware aspect, the present disclosure pertains to a computer program that is able to be used on a management entity as defined above, the program comprising code instructions that, when said program is executed by a processor, performs the steps of the management method that are defined above.

According to another hardware aspect, the present disclosure pertains to a data medium on which at least one series of program code instructions for performing a management method as defined above has been stored.

According to a second functional aspect, the present disclosure relates to a method for managing the transmission of description files associated with a first content that is broadcast in real time, the segments of which are described in respective description files, characterized in that it comprises, following a request to access the first content, transmission both of description files associated with this first content at a given frequency and of description files associated with a second content at another frequency.

According to another hardware aspect, the present disclosure relates to a management entity for managing the transmission of description files associated with a first content that is broadcast in real time, the segments of which are described in respective description files, characterized in that it comprises a transmission module that is able, following a request to access the first content, to transmit both description files associated with this first content at a given frequency and description files associated with a second content at another frequency.

According to another hardware aspect, the present disclosure relates to a content server comprising a second entity as defined above.

According to another hardware aspect, the present disclosure relates to a computer program that is able to be used on a second management entity as defined above, the program comprising code instructions that, when said program is executed by a processor, perform the steps of the method that are defined in connection with the second functional aspect.

Lastly, according to another hardware aspect, the present disclosure relates to a data medium on which at least one series of program-code instructions for performing a method for managing the transmission of description files has been stored.

The aforementioned media may be any entity or device capable of storing the program. For example, a medium may comprise a storage means, such as a ROM, for example a CD-ROM or a microelectronic circuit ROM, or a magnetic storage means, for example a hard disk. Moreover, an information medium may be a transmissible medium such as an electrical or optical signal, which may be routed via an electrical or optical cable, by radio or by other means. The program according to an aspect of the present disclosure may, in particular, be downloaded over the Internet. As an alternative, the information medium may be an integrated circuit in which the program is incorporated, the circuit being designed to perform or be used for performing the method in question.

### BRIEF DESCRIPTION OF THE DRAWINGS

One or more aspects of the present disclosure will be better understood on reading the description that follows, which is given by way of example and with reference to the appended drawings, in which:

FIG. 1 shows an architecture for streaming over the Internet based on the use of HTTP adaptive streaming according to one embodiment of the method of the present disclosure;

FIG. 2 schematically illustrates the hardware structure of a server that is able to transmit description files;

FIG. 3 schematically illustrates the hardware structure of a playback device that is able to play back multimedia streams in real time;

FIG. 4 illustrates a content and the segments available for this content;

FIG. 5 illustrates one embodiment of the method of the present disclosure; this figure illustrates the communication between the playback device and the content server when a content is accessed.

### DETAILED DESCRIPTION OF ILLUSTRATIVE EMBODIMENTS OF THE DISCLOSURE

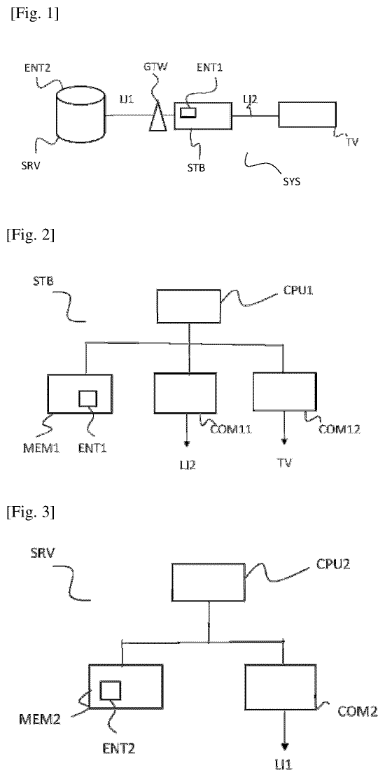

FIG. 1 shows a computer system SYS in which a content distribution network, which is called a CDN by those skilled in the art, is used, from which content is transmitted to client devices or content playback devices and description files associated with the multimedia content are transmitted.

In our example, the system SYS comprises a single playback device STB. However, the present disclosure applies to any number of playback devices.

The playback device is for example a digital playback device such as a decoder.

Here, the focus of the multimedia content is on a video content corresponding for example to a television channel on which television programs referred to as live, i.e. broadcast in real time, are broadcast. A live program can be a program that is captured live (for example a sports event) or that has already been captured (for example a television program recorded by the channel).

In our example, the playback device STB is connected to a rendering terminal TV such as a television.

In our example, the playback device STB is connected to a port of the rendering device TV; the playback device STB and the rendering device TV could also form one and the same device.

In our example, the playback device STB is located in a local area network LAN managed by a home gateway GTW. The context of the local area network is given by way of example and could easily be transposed to a best-effort Internet network, a company network, etc. It will be seen hereinafter that the playback device STB comprises a first management entity ENT1.

The gateway GTW is able to communicate via a communication link LI1, which may be a telecommunications network such as a wide area network WAN known to those skilled in the art.

The computer system SYS uses a content distribution network, called a CDN by those skilled in the art, from which content is transmitted to client devices or content playback devices STB.

The CDN consists of servers networked in the wide area network; these servers interact in order to make multimedia content available to the users in unicast mode. In order to simplify the present disclosure, a single content server SRV will be shown in FIG. 1 to represent the CDN. The content server SRV is located, in our example, in the wide area network WAN.

The content server SRV receives, for example, channels of digital-television content originating from a television broadcast network (not shown) and makes them available to client terminals, here the playback device STB, in real time.

In our example, the content C1 is made available in unicast mode in a given format. Such a content C1 is, for example, a content downloaded in adaptive streaming mode. The MPEG-DASH (Dynamic Adaptive Streaming over HTTP) standard is a format standard for audiovisual broadcast over the Internet; this standard is based on preparing the content in various representations of variable quality and bit rate, which are divided into segments of short duration (of about a few seconds), also called ‘chunks’ by those skilled in the art. Each of these segments is made available individually by means of a protocol for exchange between the rendering terminal and the server providing multimedia content. The protocol mainly targeted is the HTTP protocol, but other protocols (for example FTP) may also be used. The organization of the segments and the associated parameters are published in a description file in the XML format. The details of this form of download will not be gone into further since they are irrelevant to the present disclosure.

An example of a manifest file or ‘description file’ (MPD) according to the MPEG-DASH standard and containing the description of content available in three different qualities (N1=512 kb/s, N2=1024 kb/s, N3=2048 kb/s) of the fragmented (or segmented) content is presented in Table 1. This simplified description file describes digital content in an XML (extended Markup Language) syntax, comprising a list of content in the form of segments that are conventionally described between a start tag (<SegmentList>) and an end tag (</SegmentList>). The division into segments makes it possible in particular to adapt finely to fluctuations in bandwidth. Each segment corresponds to a certain duration (“duration” field) with multiple quality levels, and allows their addresses (URL-Uniform Resource Locator) to be generated. This generation is performed, in this example, using the elements “BaseURL” (“HTTP://server.com”), which indicates the address of the content server, and “SegmentURL”, which lists the complementary portions of the addresses of the various segments:
“C1_512kb_1.mp4” for the first fragment of the content “C1” at 512 kilobits per second (“kb”) in the MPEG-4 format (“mp4”),
“C1_512kb_2.mp4” for the second fragment,
etc.

FIG. 2 shows an architecture of a playback device STB. This device STB comprises, conventionally, memories MEM1 associated with a processor CPU1. The memories may be read-only memories (ROMs) or random access memories (RAMs) or flash memories.

The playback device STB can transmit a content to be rendered to the rendering device TV via a communication module COM12. This module COM12 is for example an HDMI link.

The playback device STB communicates with the gateway via an Ethernet module for wired local communication or via a Wi-Fi radio module for wireless local communication with the residential gateway GTW. The module in question is referenced COM11 in FIG. 2.

The playback device STB comprises an HAS module (not shown) that is able to manage download of segments of the content. The playback device STB also comprises a management entity ENT1, referred to hereinafter as the second management entity, that is able to read a description file constructed specifically during playback in restart mode, as explained below. The HAS module and the first entity ENT1 may form just a single entity, in which case the HAS module is integrated in the first entity ENT1, or may be separate from each other.

With reference to FIG. 3, the server SRV is also equipped with at least one processor CPU2 and with memories MEM2 for carrying out information processing. The server is also equipped with a management entity ENT2, referred to as the second management entity, that is able to manage the transmission of a content and the description file associated with the content from the server SRV to one or more playback devices, here to the playback device STB. The server SRV communicates with the gateway GTW via a WAN. The server comprises, for communication with the WAN, a communication module referenced COM2 in FIG. 3. The transmission of the description file rather than the transmission of the segments will be the primary focus hereinafter.

A schematic view of a main content C1 divided into segments and stored in the content server SRV is now presented in relation to FIG. 4. More specifically, the HAS content server presents a video C1 in the form of segments C1i@Nj that are encoded at various encoding rates Nj, the index i denoting a temporal identifier of the segment C1i@Nj.

The HAS module, called the conventional form of download below, of the playback device STB is responsible for retrieving the segments from the HAS content server, choosing the video quality Nj according to the available network resources. The way in which the HAS module chooses the encoding rate for the next video segment to be downloaded is not described in more detail here. It will be recalled that, more often than not, the general principle of such algorithms is based on downloading a first segment at the lowest encoding rate proposed in the description file, and on evaluating the time to retrieve this first segment. On that basis, the HAS module evaluates whether, according to the size of the segment and the time taken to retrieve it, network conditions permit the next segment to be downloaded at a higher encoding rate. Certain algorithms are based on a gradual increase in the quality level of the downloaded segments of content; others propose riskier approaches, with jumps in the levels of the encoding rates for the successive segments.

In the conventional case, if a video segment lasts three seconds, it must not take the HAS module more than 3 seconds to retrieve the segment, in order to permit the playback device STB to render the content without interruption. It is therefore necessary for the HAS module to find the best compromise between the highest possible rendering quality, and therefore the highest possible encoding rate, and the time to download the segment, which must be short enough to permit continuous rendering on the television set TV.

First, the HAS module retrieves the description file that corresponds to the video content C1 in order to discover the available segments of the video content C1, and the various associated video qualities Nj. In the example of FIG. 4, the content C1 is for example proposed in the form of segments having a duration of 3 s, with a first encoding rate N1=400 kb/s, a second encoding rate N2=800 kb/s, a third encoding rate N3=1200 kb/s, etc.

In a normal operating mode, which is not illustrated in FIG. 4, the HAS module downloads, for example, the successive segments C11@N1 (i.e. the first time segment at an encoding rate of 400 kb/s), then C12@N3 (i.e. the second time segment at an encoding rate of 1200 kb/s), then C13@N3 (i.e. the third time segment at an encoding rate of 1200 kb/s), etc.

The various segments downloaded by the HAS module are then transmitted to a display module that is able to request display on the television set TV.

The algorithm used by the HAS module to determine which segment must be downloaded at which encoding rate in normal operating mode is irrelevant to the present disclosure. This algorithm will therefore not be described in more detail here.

When a user accesses a live stream that is broadcast in real time (live content) using HTTP adaptive streaming (HAS), the playback device STB, by which is implied the HAS entity installed on this device, retrieves, usually every 2 seconds, a description file, called a realtime description file below, that generally describes the last sixty seconds of the stream (30 segments of 2 seconds). A decision may then be taken to buffer a certain portion of the stream (up to 60 seconds maximum, therefore); the video segments are of short duration because it is desirable to be as close as possible to truly live, i.e. the event being filmed, for example a football match. It is also for this reason that the description file is retrieved every two seconds and that buffer depth is usually limited to around fifteen seconds so as not to give rise to too great a lag between the football match and its being rendered on a screen.

According to an aspect of the present disclosure, when a content being broadcast is accessed, the playback device STB will receive at a given frequency, for example every two seconds, not only the description file associated with the requested content but also other description files associated with another content being broadcast, at another transmission frequency, for example every thirty seconds.

It will be seen hereinafter, in embodiments, that the present disclosure can be used in the playback device STB and/or in the server SRV.

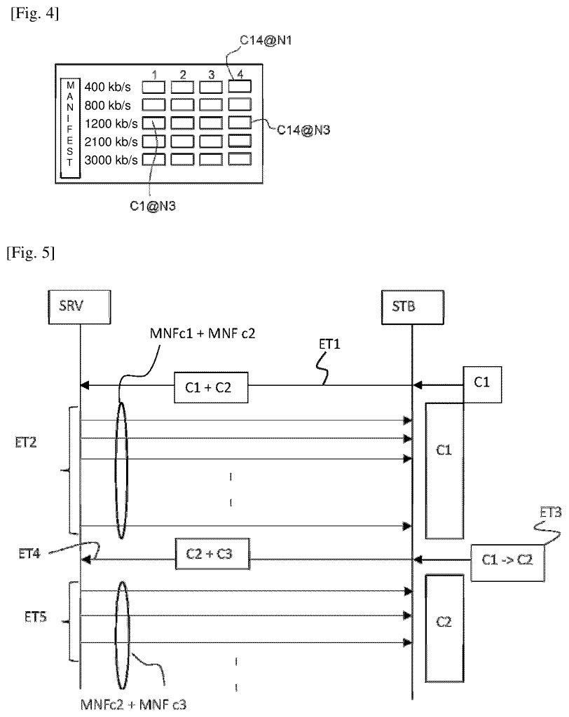

FIG. 5 illustrates one embodiment of the method of the present disclosure. This FIG. 5 shows two vertical axes corresponding to two entities, namely the first entity ENT1 present on the playback device STB and the second entity ENT2 present on the server SRV, respectively. FIG. 5 illustrates the data exchanges that take place between the playback device STB and the content server SRV.

It will be noted that this FIG. 5 illustrates only some of the messages that are useful to understanding the present disclosure. For example, after a description file has been received by the playback device STB, the latter normally requests access to the segments described in this received description file; we have chosen not to show these access messages because they are irrelevant to the present disclosure.

The steps are as follows:

In a step referenced ET1 (C1+C2), the playback device STB requests access to a content C1, referred to as the first content. The access request may originate from an access request coming from a remote control device.

Following the transmission of the request to access the first content C1, the playback device STB in return receives the description file associated with the selected content and also a description file associated with another content, referred to as the second content.

In this first embodiment, in the first step ET1, the playback device STB transmits not only a request to access the first content C1 but also a request to access the second content C2. It will be seen in another embodiment that the server SRV can receive a request to access a first content and in return transmit the description file associated with the selected content and also a description file associated with the second content; in this embodiment, the playback device STB is relieved of managing the transmission of the request to access the second content C2.

In a step ET2, the playback device STB in return receives, successively, description files associated with the first selected content C1 after they have each been produced on the server SRV but also description files associated with the second content C2 after they have each been produced on the server SRV.

Courtesy of the description files associated with the first content, the playback device STB can access the segments described in these files and can read them and request that the content be rendered on the rendering device TV.

At this stage, the playback device STB receives description files associated with the second content C2 and stores them until a potential request to read this second content C2 is received.

It is now assumed that the user zaps from the first content C1 to the second content C2 using their remote control in a step ET3, for example by pressing the “+” key on the remote control. The playback device STB receives the command to access the second content C2.

In a step ET4, following receipt of the command to access the second content C2, the playback device STB transmits to the server SRV a request to access the second content C2; this request is received by the SRV; the latter continues to transmit the description files associated with this second content C2.

At this stage, the SRV can stop or continue transmitting the description files associated with the first content C1.

In this first embodiment, the playback device STB already receiving the description files relating to the second content C2 can access the segments described in the last received description file and read the segments of this second content C2 in a step ET5.

FIG. 6 illustrates a second embodiment that can be used in isolation or in combination with the first embodiment.

In this second embodiment, in a step referenced ET1 (C1), the playback device STB requires access to a first content C1. The access request may originate from an access request coming from a remote control device.

In this embodiment, the server SRV receives the request to access the first content C1 and requests a return transmission of description files associated with the requested first content and description files associated with a second content C2.

In this embodiment, the playback device STB does not transmit a request to receive a second content C2; the server SRV spontaneously decides to transmit description files relating to a second content C2.

The other steps are the same as those described with reference to FIG. 5.

The embodiments described above can have variants:

According to one possible variant, access to the first given content C1 also entails downloading some of the segments described in the description file associated with the second content. In our example, only two segments are downloaded; this allows the downloaded segments to be played back without waiting.

In addition, the description files associated with the first content are successively received at a given frequency. According to an aspect of the present disclosure, the description files associated with the second content are received at another frequency, in our example at a lower frequency. However, the same frequency can be used if in particular there is no bandwidth problem. The description files associated with the second content can also be received at a variable frequency that is dependent, for example, on the available bandwidth.

According to another variant, if there are multiple second contents, the description files associated with these two contents can be received at different times so as not to receive them at the same time.

According to another variant, the step ET4 does not take place; since the playback device STB already receives the second content, it does not need to request access to this second content from the server SRV. Nevertheless, the transmission of a request to access the second content C2 makes it possible to inform the server SRV, the latter being able to take measures accordingly, such as transmitting description files associated with a third content C3.

According to another variant, the present disclosure can be used whenever a content is accessed. Here, after the command to access the second content C2 has been received by the playback device STB, in a step ET4, the playback device STB transmits a request to access a third content C3. The steps described above are carried out again.

In the previous embodiments, a single second content C2 is requested; however, the number of contents requested in addition to the content to be rendered C1 is arbitrary.

The second content C2 can also be chosen in various ways, as follows:

In a first way, the second content C2 is a content adjacent to that being rendered, namely the first content C1. This variant is practical when zapping to change channel by incrementing by one unit or decrementing by one unit.

In a second way, which can be used as an alternative or in addition to the first variant, the second content C2 is a content chosen according to a user profile; this profile can, for example, explicitly include favorite television channels. These can also be deduced by monitoring the habits of the user over a given time range.

In a third way, which can be used as an alternative or in addition to the previous variants, the second content C2 is chosen according to a foreseeable level of audience. For example, if the television channels France2 and M6 broadcast a program with a large audience at a time t, the description files relating to these channels are transmitted successively in addition to the description files relating to the content being rendered.

Lastly, it is also specified here that the term “entity” may correspond either to a software component or to a hardware component or to a set of hardware and software components, a software component itself corresponding to one or more computer programs or subroutines or, more generally, to any element of a program that is able to perform a function or a set of functions as described for the modules concerned. In the same way, a hardware component corresponds to any element of a hardware assembly that is able to perform a function or a set of functions for the module concerned (integrated circuit, chip card, memory card etc.)

TABLE 1
example of a manifest file

```
<?xml version=“1.0”?>
<MPD xmlns:xsi=“http://www.w3.org/2001/XMLSchema-instance”
  xmlns=“urn:mpeg:DASH:schema:MPD:2011”
  xsi:schemaLocation=“urn:mpeg:DASH:schema:MPD:2011 DASH-MPD.xsd”
  type=“dynamic” profiles=“urn:mpeg:dash:profile:isoff-live:2011”>
<Representation id=“0” codecs=“avc1” mimeType=“video/mp4”
width=“1024” height=“768” startWithSAP=“1” bandwidth=“46986”>
<BaseURL>HTTP://server.com/</BaseURL>
<!-- Contenu C1 à N1=512kb -->
<SegmentBase>
    <Initialization sourceURL=“C1_15sec_512kb/C1_512kbit_dash.mp4”/>
</SegmentBase>
<SegmentList duration=“10”>
    <SegmentURL media=“C1_512kb_1.mp4”/>
    <SegmentURL media=“ C1_512kb_2.mp4”/> ....
</SegmentList>
<!-- Contenu C1 à N2=1024kb -->
<SegmentBase>
    <Initialization sourceURL=“C1_15sec_500kbit/C1_1024kbit_dash.mp4”/>
</SegmentBase>
<SegmentList duration=“10”>
    <SegmentURL media=“C1_512kb_1.mp4”/>....
</SegmentList>
<!-- Contenu C1 à N3=2048kb -->
<SegmentBase>
    <Initialization sourceURL=“C1_15sec_512kb /C1_2048kbit_dash.mp4”/>
</SegmentBase>
<SegmentList duration=“10”>
    <SegmentURL media=“C1_2048kb _1.mp4”/>...
</SegmentList>
<!-- Contenu C2 à N1=512kb -->
<SegmentBase>
    <Initialization sourceURL=“ C2_15sec_500kbit/C2_512kbit_dash.mp4”/>
</SegmentBase>
<SegmentList duration=“10”>
    <SegmentURL media=“ C2_512kb_1.mp4”/> ....
</SegmentList>
<!-- Contenu C2 à N2=1024kb -->
<SegmentBase>
    <Initialization sourceURL=“C2_15sec_500kbit/C1_1024kbit_dash.mp4”/>
</SegmentBase>
<SegmentList duration=“10”>
    <SegmentURL media=“C2_1024kb_1.mp4”/>....
</SegmentList>
<!-- Contenu C2 à N3=2048kb -->
<SegmentBase>
    <Initialization sourceURL=“C2_15sec_500kbit/C1_2048kbit_dash.mp4”/>
</SegmentBase>
<SegmentList duration=“10”>
    <SegmentURL media=“C1_2048kbit _1.mp4”/>...
</SegmentList>
  ....
</SegmentList>
</MPD>
```

Although the present disclosure has been described with reference to one or more examples, workers skilled in the art will recognize that changes may be made in form and detail without departing from the scope of the disclosure and/or the appended claims.

What is claimed is:

1. A management method implemented by a management entity device and comprising:
managing access by a playback device to a first segmented content comprising segments described in respective description files, wherein access to the first segmented content results in receipt of both description files associated with the first segmented content at a given frequency and description files associated with a second content at another frequency.

2. The management method as claimed in claim 1, wherein the access to the first content also results in some of the segments described in the description file associated with the second content being downloaded.

3. The management method as claimed in claim 1, wherein the description files associated with the second content are received at a lower frequency than the given frequency.

4. The management method as claimed in claim 1, wherein the second content is a content adjacent to the first segmented content.

5. The management method as claimed in claim 1, wherein the second content is a content included in a predefined list of contents.

6. The management method as claimed in claim 1, comprising:
receiving a request to access the first segmented content;
transmitting the request to access the first segmented content to a server; and
in response to transmitting the request, receiving the description files associated with the first segmented content and the description files associated with the second content.

7. The management methos as claimed in claim 6, wherein transmitting the request to access the first segmented content comprises:
in response to receiving the request to access the first segmented content, transmitting the request to access the first segmented content and a request to access the second content to the server.

8. A management entity comprising:
at least one processor; and
at least one non-transitory computer readable medium comprising code instructions that when executed by the at least one processor configure the management entity to manage access by a playback device to a first segmented content comprising segments described in respective description files, wherein the managing comprises, following access to the first segmented content, requesting receipt of description files associated with the first segmented content at a given frequency and of description files associated with a second content at another frequency.

9. The playback device comprising the management entity as defined in claim 8.

10. A non-transitory computer readable data medium on which at least one series of program code instructions is stored, which when executed by at least one processor of the management entity device configure the management entity device to perform the method as claimed in claim 1.

11. A management method implemented by a management entity device and comprising:
managing transmission of description files associated with a first content that is broadcast in real time and comprises segments described in respective description files, wherein the managing comprises, following receiving a request to access the first content, transmitting both description files associated with the first content at a given frequency and description files associated with a second content at another frequency.

12. A management entity comprising:
at least one processor; and
at least one non-transitory computer readable medium comprising code instructions that when executed by the at least one processor configure the management entity to manage transmission of description files associated with a first content that is broadcast in real time and comprises segments described in respective description files, wherein the managing comprises, following receiving a request to access the first content, transmitting both description files associated with the first content at a given frequency and description files associated with a second content at another frequency.

13. A content server comprising the management entity as claimed in claim 12.

14. A non-transitory computer readable data medium on which at least one series of program code instructions is stored, which when executed by at least one processor of the management entity device configure the management entity device to perform the method as claimed in claim 11.
